(19) United States
(12) Patent Application Publication
(10) Pub. No.: US 2008/0195946 A1
(43) Pub. Date: Aug. 14, 2008

(54) Online personal coach for software applications

(75) Inventor: Yaron Peri-Glass, Raanana (IL)

Correspondence Address: HICKMAN PALERMO TRUONG & BECKER, LLP, 2055 GATEWAY PLACE, SUITE 550, SAN JOSE, CA, 95110, US

(73) Assignee: Cadence Design Systems, Inc.

(21) Appl. No.: 11/706,525

(22) Filed: Feb. 13, 2007

(51) Int. Cl. G06F 3/048

(52) U.S. Cl. 715/715

(57) ABSTRACT

An “online personal coach” provides a mechanism for leading a computer application user in performing tasks using the application, by coaching the user while the user is executing real tasks. Once a user requests help, the coach provides the help inside the application context, step by step, while actually visiting and pointing to the relevant areas inside the application user interface. The coach guides the user in performing tasks by relating to and using the user's real data or other input. Thus, the coach is an interactive mechanism integrated into an application, which assists users in performing real application operations rather than simulated operations or demonstrations. As the coach is leading and instructing the user through a task, a “floating frame” slides on top of the user interface from one place to another, as required by the specific task.

### FIELD OF THE INVENTION

The present invention relates generally to computer software applications and, more specifically, to an online personal coach that interactively leads a user to achieve particular goals within a software application.

### BACKGROUND

One of the major challenges for software application users is to effectively use those applications, by accomplishing their goals quickly and with the required quality. However, it is common to have sophisticated application features ignored or misused due to lack of knowledge on the users' part. This challenge is growing every day, in view of the large number of new applications and technologies. Most users, whether they are students, professionals or casual users, have to be familiar with multiple computerized tools and deal with the different approaches and unique methodologies of the various tools.

Various general approaches to assisting users with using various software applications may include (a) designing easy-to-use user interfaces (i.e., “Transparent User Interfaces”); (b) provide information to users about how to use the application, such as through manuals, tutorials, demonstrations, videos, etc.; (c) providing users a mechanism for obtaining information regarding a specific issue, such as through an online help feature; and (d) providing shortcuts for executing pre-defined tasks, such as with a “wizard.”

While standardization and innovations in application user interfaces have made computer applications easier to use, it is clear that getting started with unfamiliar interfaces, learning advanced features, and understanding application domain concepts remain a challenge for many users. While there have been many attempts to design self-explanatory user interfaces, it is now a consensus among researchers in this area of technology that designing a transparent user interface is not practical and, at best, must be provided in concert with other means. Thus, improving the user interface is good, but this approach does not remove the need for further assistance.

User manuals or guides are probably the oldest solution for this problem. Typically, a complete user manual is supplied with every copy of a software application. However, it is clear from research that users rarely turn to a user manual, mainly because use of user's manuals is a slow, uncomfortable, and inefficient process.

The traditional and most popular mechanism for educating users is through online help systems. Online help systems are available for most applications and are readily accessible, have hypertext links, are searchable, and are designed to provide useful and usable information on the corresponding application's usage. However, research also shows that there are many cases where online help systems are used only when users cannot proceed with their task. Thus, large parts of the help information are never consulted at all, even though there is no doubt about the need for providing help. Research shows that online help systems are not a cure-all for users because users still fail to find clear answers quickly using those systems. Another reason for the low usage of online help systems is because users, who are focused on the main application, conceive the usage of an online help system as a distraction. The usage of the help system is conceived as another task which requires the user to change focus. Another reason identified for not using online help systems is because that many users tend to put the minimal amount of effort into completing their tasks. Such users do not want to learn or become highly-skilled, rather they simply want to complete their current task and continue to the next task. Hence, because opening an online help system requires an additional effort, such users simply avoid it and try to solve their problems by themselves. In many cases, this results in ineffective user steps, many mistakes, and low quality work product.

There are some variants of online help systems which try to appear more user-friendly and “personal”. For example, the Microsoft Office Assistant, an animated paper clip with expressive eyes and active eyebrows that offers user tips, has been scorned by developers who have little use for its cuteness and intrusiveness. The animated paper clip allows users to enter keywords for looking up self-help instructions from a repository. However, the main difference between such an assistant and a standard online help system is in the way the user asks for help, and not in the way the help is located and provided. Thus, the paper-clip approach does not really offer the user any practical advantage in comparison with the regular online help, and has the same limitations as online help.

Tutorials are a step-by-step online process, which supply users with instructions of how to perform a specific task. Tutorials allow users to learn how to perform various tasks, reflect capabilities of the application, and demonstrate various concepts. Many of the modern computer applications have elaborate tutorials which teach many of the capabilities of those applications. Tutorials are powerful tools, by which the user can really learn important information regarding various tasks. However, the tutorial concept has its share of limitations. The biggest difficulty is that tutorials teach users how to perform some predefined example tasks, but not how to perform users' real-world problems. Thus, many required tasks are not described in the tutorial. Tutorial flow is static in nature, very structured, and very well defined, with regard to a specific problem using specific, well defined parameters. However, each user's use of an application is typically somewhat unique and might require different steps and specific, user dependent parameters. The disparity between using a tutorial to learn about a predefined example and solving a real user task is, in many cases, significant. Another limitation is that tutorials are external applications and, therefore, suffer from the same difficulty as mentioned above in reference to online help systems, i.e., users do not want to switch their focus from the main application to another tool, and back and forth, which is an annoying process that users tend to avoid.

A “wizard” is a concept in which the user is presented with a set of structured screens which relate to a specific task, in order to capture user input for this task. Wizards are powerful and popular tools and are widely used in some computer applications because wizards, unlike tutorials, relate to the user's real data for the relevant task. By using wizards, users do not need to learn how to use the tool components, but only have to answer the wizard's questions. However, one of the major limitations of the wizard concept is that it can be used only in places where the user tasks can be structured into some very accurate set of parameters. Unfortunately, in the real world, there are multiple tasks which cannot be so strictly structured into a pre-defined set of parameters. In fact, most computer applications do not include wizards because of this inflexibility limitation. For example, the various office applications like word-processor, spreadsheet, and presentation applications are not based in a large part on wizards. Rather, such applications allow users to work freely within the application, and provide some specific wizards to help the users to perform some specific tasks. Another major limitation is that wizards do not teach anything. A user that used a wizard to execute a task will not know how to execute a similar task using the application user interface.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a first screenshot of a graphical user interface (GUI) illustrating an example of an online personal coach guiding a user through a flow of steps to perform a task with a software application, according to an embodiment of the invention;

FIG. 2 is a second screenshot of a graphical user interface (GUI) illustrating an example of an online personal coach guiding a user through a flow of steps to perform a task with a software application, according to an embodiment of the invention;

FIG. 3 is a third screenshot of a graphical user interface (GUI) illustrating an example of an online personal coach guiding a user through a flow of steps to perform a task with a software application, according to an embodiment of the invention;

FIG. 4 is a fourth screenshot of a graphical user interface (GUI) illustrating an example of an online personal coach guiding a user through a flow of steps to perform a task with a software application, according to an embodiment of the invention;

FIG. 5 is a fifth screenshot of a graphical user interface (GUI) illustrating an example of an online personal coach guiding a user through a flow of steps to perform a task with a software application, according to an embodiment of the invention;

FIG. 6 is a sixth screenshot of a graphical user interface (GUI) illustrating an example of an online personal coach guiding a user through a flow of steps to perform a task with a software application, according to an embodiment of the invention;

FIG. 7 is a seventh screenshot of a graphical user interface (GUI) illustrating an example of an online personal coach guiding a user through a flow of steps to perform a task with a software application, according to an embodiment of the invention;

FIG. 8 is an eighth screenshot of a graphical user interface (GUI) illustrating an example of an online personal coach guiding a user through a flow of steps to perform a task with a software application, according to an embodiment of the invention;

FIG. 9 is a ninth screenshot of a graphical user interface (GUI) illustrating an example of an online personal coach guiding a user through a flow of steps to perform a task with a software application, according to an embodiment of the invention;

FIG. 10 is a tenth screenshot of a graphical user interface (GUI) illustrating an example of an online personal coach guiding a user through a flow of steps to perform a task with a software application, according to an embodiment of the invention;

FIG. 11 is a flow diagram illustrating a method for leading a user in performing a task using at least one software application, according to an embodiment of the invention; and

FIG. 12 is a block diagram that illustrates a computer system upon which an embodiment of the invention may be implemented.

### DETAILED DESCRIPTION OF EMBODIMENTS OF THE INVENTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Functional Overview of Embodiments

An “online personal coach” (referred to herein simply as the “coach”) provides a mechanism for leading a computer application user in performing tasks using the application, by coaching the user while the user is executing real tasks. The coach teaches the user how to use the application to perform certain tasks, and provides the user means for obtaining information regarding specific tasks. The coach exists “inside” the application and provides the user instructions in real time while the user is executing a real task. Moreover, those instructions are provided in a manner that requires only a low workload focus from the user, by using visual means or any other media such as audio.

A noteworthy aspect of the coach is the manner in which information is provided to the user. Unlike any other solution, once the user requests help, the coach will provide the help inside the application context, step by step, while actually visiting and pointing to the relevant areas inside the application user interface. Furthermore, the coach guides the user in performing tasks by relating to and using the user's real data or other input. Thus, the coach is an interactive mechanism integrated into an application which assists users in performing real application operations, rather than simulated operations or demonstrations.

As the coach is leading and instructing the user through a task, step-by-step, a “floating frame” slides on top of the user interface from one place to another, as required by the specific task. The coach graphically points to, and in some cases emphasizes, various areas and/or user interface components within the user interface, while instructing the user how to act in relation to the user interface. The coach can be configured to provide the user with feedback regarding each step after it is performed, before continuing to the next step in the task flow.

The coach embodies the notion of learning by doing. For example, users learn to use the application in a similar manner as learning to drive a car by taking driving lessons, whereby the driver/user is seated behind the steering wheel/computer, doing the actual driving/execution of the tasks while getting instructions from the teacher/coach. After a while, when the driver/user is skilled enough, the driver/user can continue driving/using the application without any help from the teacher/coach.

### Online Personal Coach

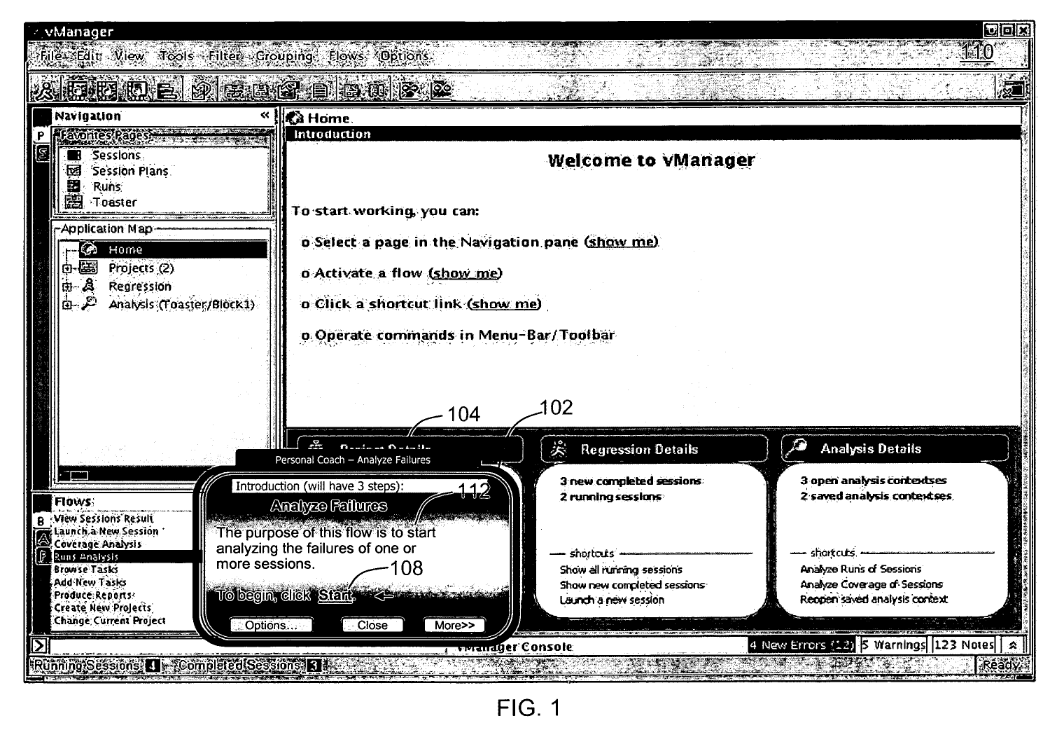

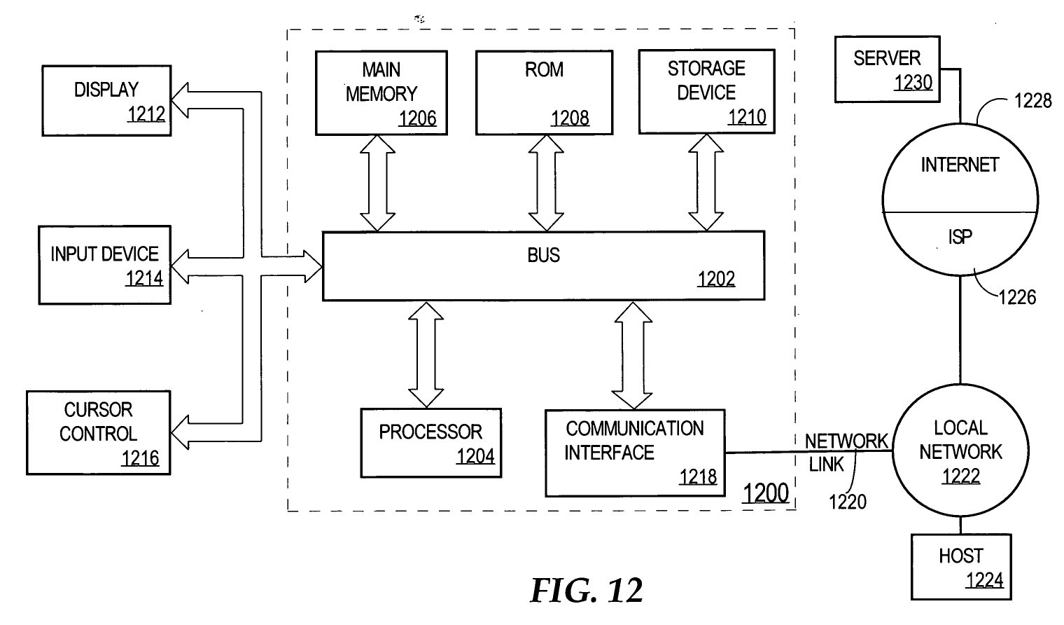

Embodiments of the invention are described herein primarily by way of example, by describing functionality of the coach in the context of an example flow characterizing the steps of a particular task. FIGS. 1-10 are graphical user interface (GUI) screenshots illustrating an example of an online personal coach guiding a user through a flow of steps to perform a task with a software application, according to an embodiment of the invention. For example, the screenshots depicted in FIGS. 1-10 may be displayed on a computer display, such as display 1212 of computer system 1200 of FIG. 12.

In the context of describing the functionality of the coach, a “task” is characterized as one or more “steps” associated with a “flow” of operations that correspond to the task. Stated otherwise, a “flow” implements a user “task” and characterizes the “steps” constituent to the corresponding task, and each step corresponds to one or more operations that the corresponding software application performs in furtherance of performing the task.

### Introduction to a Task Flow

The screenshot of FIG. 1 depicts a floating frame 102 associated with the coach, according to an embodiment of the invention. This particular instance of the coach corresponds to a task referred to as “Analyze Failures”, as is depicted in a title bar 104 of the floating frame 102. According to an embodiment, in response to invoking the coach, the floating frame 102 displays an “Introduction” corresponding to the “Analyze Failures” task, where the introduction 112 generally describes or explains the purpose of the “Analyze Failures” task. The manner(s) in which the coach may be invoked may vary from implementation to implementation. For non-limiting examples, the coach may be invoked using one or more of a corresponding button, icon, menu item, and link, a keyword search, commencement of a task, selecting a task from a list of tasks, and the like.

As depicted, floating frame 102 comprises a “Start” link 108 which the user can interact with to request the coach to start leading the user through the “Analyze Failures” task with the software application entitled “vManager”.

Floating frame 102 comprises, for example, a window, frame, pane, or other type of dialogue box that is displayed over, or on top of, the user interface 110 corresponding to the software application, while still allowing the user to view a large portion of the user interface. Practically, floating frame 102 is an object that is displayed in a manner that covers a portion of the underlying user interface 110. The manner in which the floating frame 102 is implemented may vary from implementation to implementation. For example, the floating frame 102 may be implemented using techniques of the Java™ and/or C++ programming languages, as a matter of design choice.

According to an embodiment, floating frame 102 comprises an “Options . . . ” or similarly functioning button which provides a link to a listing of configuration options associated with the coach. For non-limiting examples, exercising the Options button may cause display of a dialogue box over the floating frame 102, where the Options dialogue box displays the following options, along with corresponding check boxes: (1) “Show Feedback for Each Step”, for specifying whether or not the user wants the coach to provide feedback when a step is completed, which is described in greater detail herein; (2) “Show Introduction”, for specifying whether or not the user wants the coach to provide introductions to the tasks; and (3) “Show Summary”, for specifying whether or not the user wants the coach to provide summaries of tasks upon completion of the tasks, which is described in greater detail herein. Features that can be configured via the Options button may vary from implementation to implementation and are not limited to the foregoing features.

According to an embodiment, floating frame 102 comprises a “More” or similarly functioning button which provides a link to a listing of configuration options associated with the coach in the context of the particular task and/or step being coached. For non-limiting examples, exercising the More button may cause display of a dialogue box over the floating frame 102, or expand the size of the floating frame 102, where the More dialogue box displays the following buttons: (1) “Do It!”, for requesting that the coach execute the current step if the step is deterministic (i.e., does not require a user decision); (2) “Semi Automatic”, for requesting that the coach execute all the deterministic steps and to stop when a user decision is required; and (3) “Full Demo”, for requesting that the coach show a full demonstration of the task, making arbitrary decisions for the user instead of requiring user decisions. Features that can be requested via the More button may vary from implementation to implementation and are not limited to the foregoing features.

According to an embodiment, floating frame 102 provides a link into a more elaborate explanation of a corresponding task or step. Such a link may link into, for non-limiting examples, an HTML page, an online help system, and the like.

### Begin Leading a User Through a Task Flow

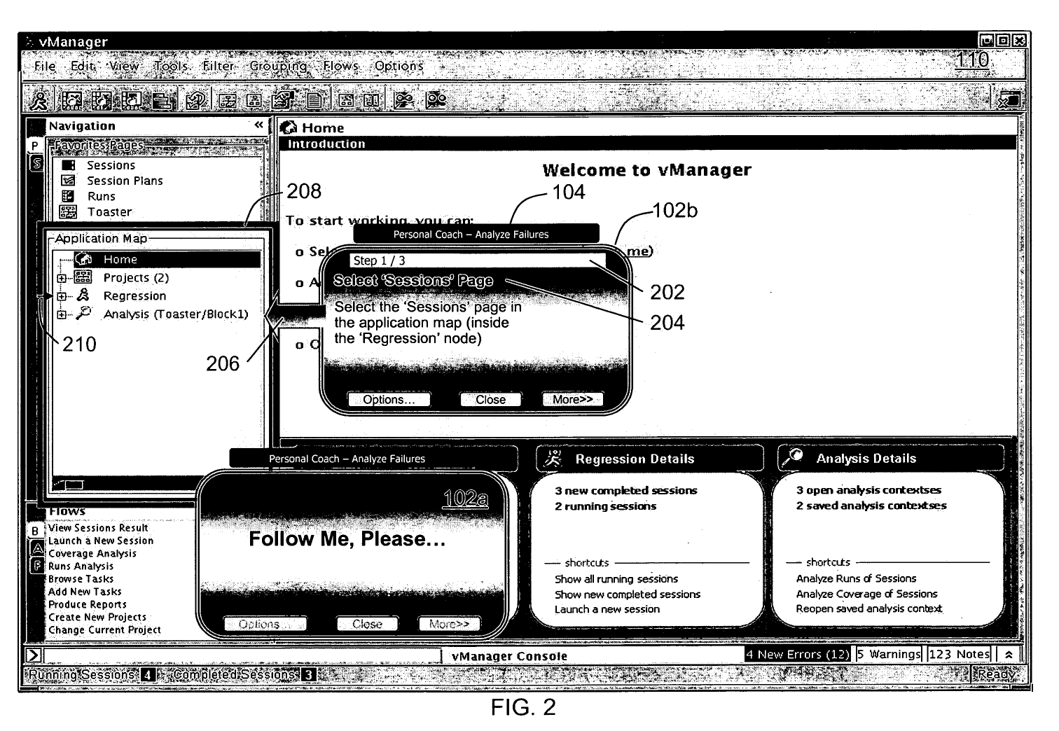

The screenshot of FIG. 2 depicts, generally, the floating frame 102 associated with the coach, in two different locations, according to an embodiment of the invention. This particular instance of the coach also corresponds to the “Analyze Failures” task, as is depicted in a title bar 104 of the floating frames depicted as floating frame 102a and floating frame 102b. Floating frames 102a and 102b may be implemented as the same frame, with its content and location changing. Alternatively, floating frames 102a and 102b may be implemented as separate instances or objects of a floating frame mechanism, generally.

In response to exercising the “Start” link 108 (FIG. 1), the floating frame 102a leads the user to another location within user interface 110 by momentarily displaying some dialogue, such as “Follow Me, Please . . . ”. The floating frame 102a then moves to a new location over user interface 110, depicted as floating frame 102b of FIG. 2. Floating frame 102b displays a step tracker 202 corresponding to the “Analyze Failures” task, where the step tracker 202 identifies with which step of the “Analyze Failures” task the floating frame 102b is associated (e.g., “Step 1/3”). Floating frame 102b also displays the title 204 of the particular step of the particular task which, in this part of the example, is the “Select ‘Sessions’ Page” step of the “Analyze Failures” task. As with floating frame 102 of FIG. 1, floating frame 102b may display the Options and More buttons.

According to an embodiment, the manner in which floating frame 102a transitions into and moves to the location of floating frame 102b is such that the floating frame appears to graphically “slide” from location to location so that the user can visually follow the movement of the floating frame to the new location. According to an embodiment, the content of floating frame 102a changes to the content of floating frame 102b upon reaching the location associated with floating frame 102b. However, the exact timing of when the content of floating frame changes may vary from implementation to implementation.

Floating frame 102b provides instructions to the user by displaying instructions about how the user should interact with a component of user interface 110, in order to cause actual performance by the software application of one or more operations associated with the first step. Furthermore, floating frame 102b graphically points to a portion of the user interface 110 in which the component appears or is contained. For example, arrow 206 points to the “Application Map” portion of user interface 110.

According to an embodiment, the portion of user interface 110, in which the user interface component associated with the step is contained, is emphasized within user interface 110. The portion of the user interface in which the component is contained may be a window, a frame, a pane, an icon, etc., depending on the design and configuration of the user interface 110. For example, FIG. 2 shows the “Application Map” area as having a bold border 208 compared to the other sections of the user interface 110. Similarly, if a given step may be performed in the software application in multiple ways, then portions of the user interface associated with each respective way to perform the step is highlighted or otherwise emphasized. For example, if a certain task may be performed via a menu selection, a toolbar icon, a link, and a button, then each of the menu selection, icon, link, and button are concurrently emphasized.

According to an embodiment, the user interface component associated with the step is graphically emphasized within user interface 110. According to a related embodiment, the user interface component associated with the step is graphically emphasized by pointing directly to the component or one of the component's ancestors, such as with arrow 210 depicted in FIG. 2. However, the manner in which the user interface component is graphically emphasized may vary from implementation to implementation. For non-limiting examples, text associated with user interface components (e.g., the links) associated with corresponding steps of a task may be displayed in bold or color, or the remaining choices other than the relevant component may be displayed as semi-transparent, and the like.

### Instruct the User About Performing a Step

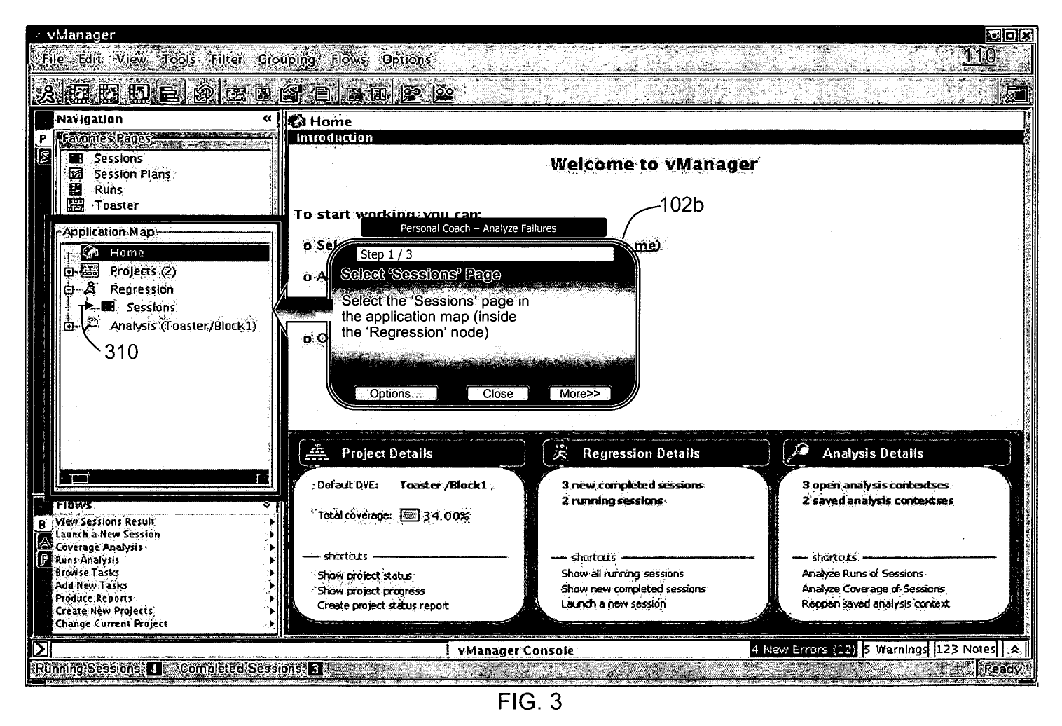

The screenshot of FIG. 3 depicts the floating frame 102b associated with the coach, according to an embodiment of the invention. In FIG. 2, the instructions displayed in floating frame 102b instruct the user to “Select the ‘Sessions’ page in the application map (inside the ‘Regression’ node)” and the Regression node is pointed at by arrow 210. In response to interacting with the directory mechanism for expanding the Regression node (e.g., the ‘+’), the software application would expand the Regression node to show the ‘Sessions’ node, as depicted in FIG. 3. According to an embodiment, the user interface component associated with the step is graphically emphasized within user interface 110, such as by pointing directly to the component, such as with arrow 310 depicted in FIG. 3. However, the manner in which the user interface component is graphically emphasized may vary from implementation to implementation.

### Provide the User Feedback About Performing a Step

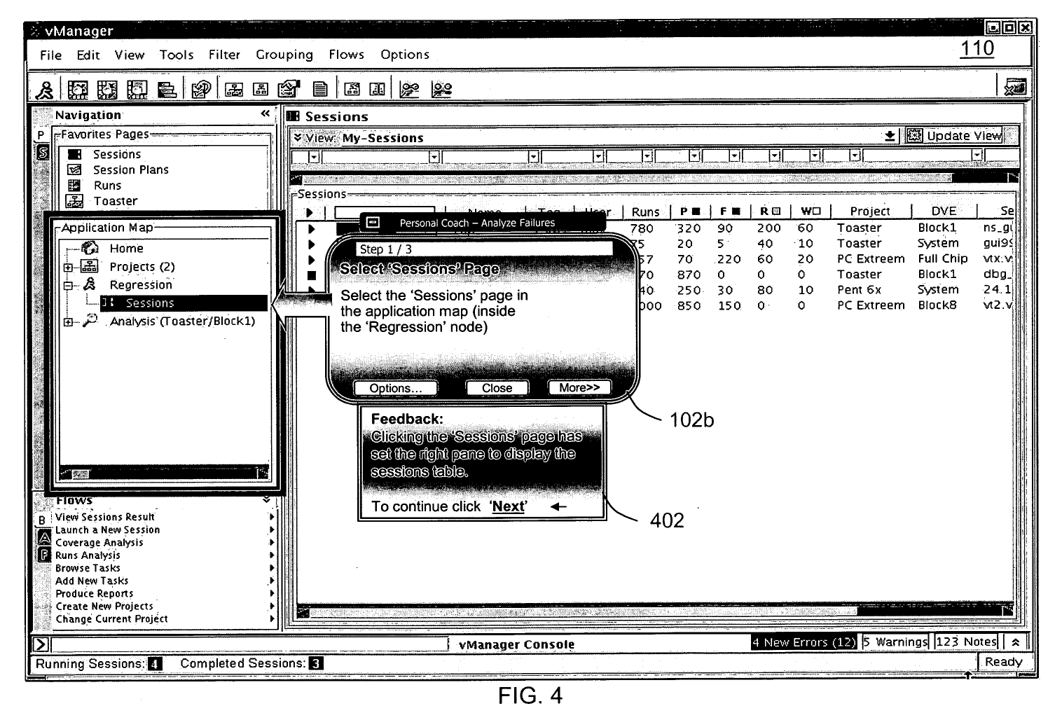

The screenshot of FIG. 4 depicts the floating frame 102b associated with the coach, according to an embodiment of the invention. In FIG. 3, the instructions displayed in floating frame 102b instruct the user to “Select the ‘Sessions’ page in the application map (inside the ‘Regression’ node)” and the Session node is pointed at by arrow 310. In response to interacting with the user interface component associated with the Session node, the software application responsively performs an action. According to an embodiment, the coach is configured to provide feedback regarding what the software application did in response to enacting a step and/or task. As depicted in FIG. 4, floating frame 102b provides such feedback to the user via a feedback frame 402. For non-limiting examples, completing a step may cause display of a dialogue box in conjunction with the floating frame 102b, or expand the size of the floating frame 102b, where the feedback frame 402 displays text describing what happened. In the example of FIG. 4, the feedback frame 402 informs that clicking on the ‘Sessions’ page set a pane to display a sessions table. According to an embodiment, feedback frame 402 comprises a “Next” link that the user can use to instruct the coach to continue with the task at hand.

Most sophisticated user interface programs comprise an event handler that handles events associated with the software application with which the user interface program is associated. Therefore, a subscriber such as the coach can subscribe to a set of one or more events or types of events handled by the user interface program's event handler. Thus, the coach listens for pertinent events so that the coach can be notified when such an event occurs. For example, the coach may subscribe to events that involve the user performing certain interactions with certain user interface components that are associated with steps of flows for which the coach application is configured to coach. Consequently, upon being notified of the occurrence of a certain event, the coach can know that the event occurred and can now provide feedback about the operation that was triggered in response to the event.

### Leading the User Further Through the Task Flow

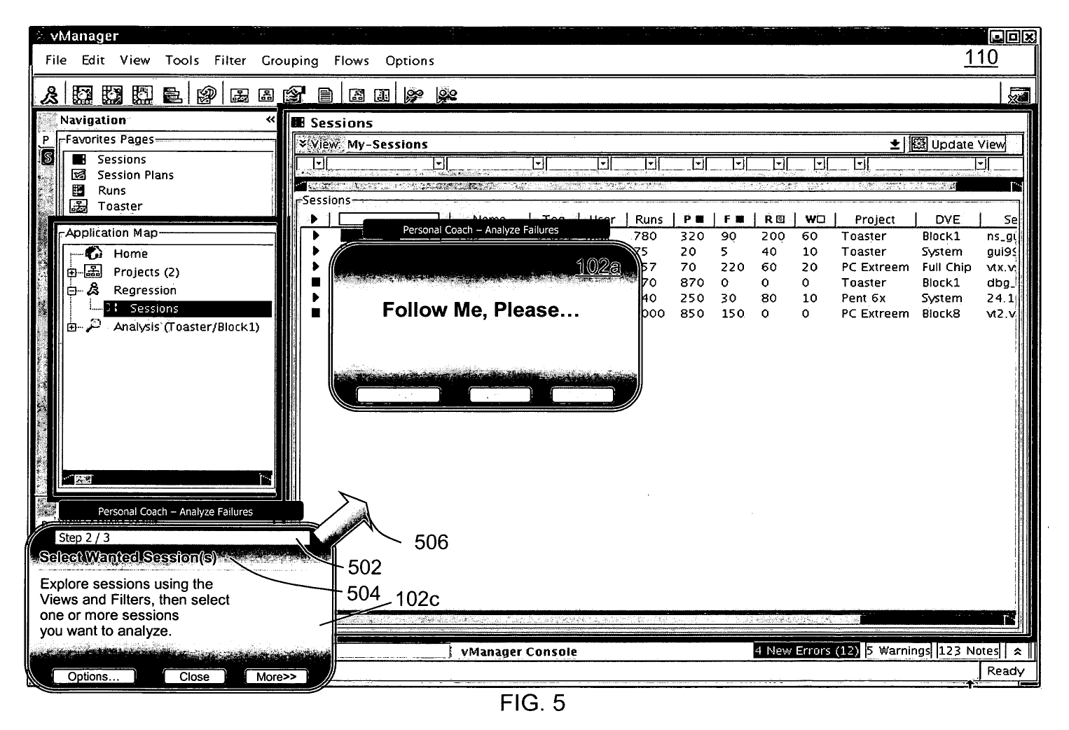

The screenshot of FIG. 5 depicts, generally, the floating frame 102 associated with the coach, in two different locations, according to an embodiment of the invention. Floating frames 102a and 102c may be implemented as the same frame, with its content and location changing. Alternatively, floating frames 102a and 102c may be implemented as separate instances or objects of a floating frame mechanism, generally.

In response to the previous step of selecting the Sessions page (see, e.g., FIG. 4), the floating frame 102a leads the user to another location within user interface 110 by momentarily displaying some dialogue, such as “Follow Me, Please . . . ”. The floating frame 102a then moves to a new location over user interface 110, depicted as floating frame 102c of FIG. 5. Floating frame 102c displays the step tracker 502 corresponding to the “Analyze Failures” task, where the step tracker 502 describes with which step of the “Analyze Failures” task the floating frame 102c is associated (e.g., “Step 2/3”). Floating frame 102c also displays the title 504 of the particular step of the particular task which, in this part of the example, is the “Select Wanted Sessions” step of the “Analyze Failures” task. As with floating frame 102 of FIG. 1, floating frame 102b may display the Options and More buttons.

As with other steps of the task, the manner in which floating frame 102a transitions into and moves to the location of floating frame 102c is such that the floating frame appears to graphically “slide” from location to location so that the user can visually follow the movement of the floating frame to the new location, according to an embodiment. According to an embodiment, the content of floating frame 102a changes to the content of floating frame 102c upon reaching the location associated with floating frame 102c. As with other steps, the exact timing of when the content of floating frame changes may vary from implementation to implementation.

Floating frame 102c provides instructions to the user by displaying instructions about how the user should interact with user interface 110, in order to cause actual performance, by the software application, of one or more operations associated with the second step of the “Analyze Failures” task. Furthermore, floating frame 102c graphically points to a portion of the user interface 110 with which the user is supposed to interact. For example, arrow 506 points to the “Sessions” pane of user interface 110.

As with the other steps, the portion of user interface 110 with which the user should interact in order to perform the second step may be emphasized within user interface 110. Similarly, if a given step may be performed in the software application in multiple ways, then portions of the user interface associated with each respective way to perform the step is highlighted or otherwise emphasized. In this particular step of the “Analyze Failures” task, there is no specific user interface component with which the user should interact, thus there is no specific user interface component that is graphically emphasized within user interface 110. However, the “Sessions” pane is emphasized with a bold border, arrow 506 points to the “Sessions” pane, and floating frame 102c instructs the user to explore sessions using the Views and Filters associated with the pane and to then select one or more sessions that the user wants to analyze. Hence, the coach is again leading, or coaching, the user about how to perform the “Analyze Failures” task with the software application.

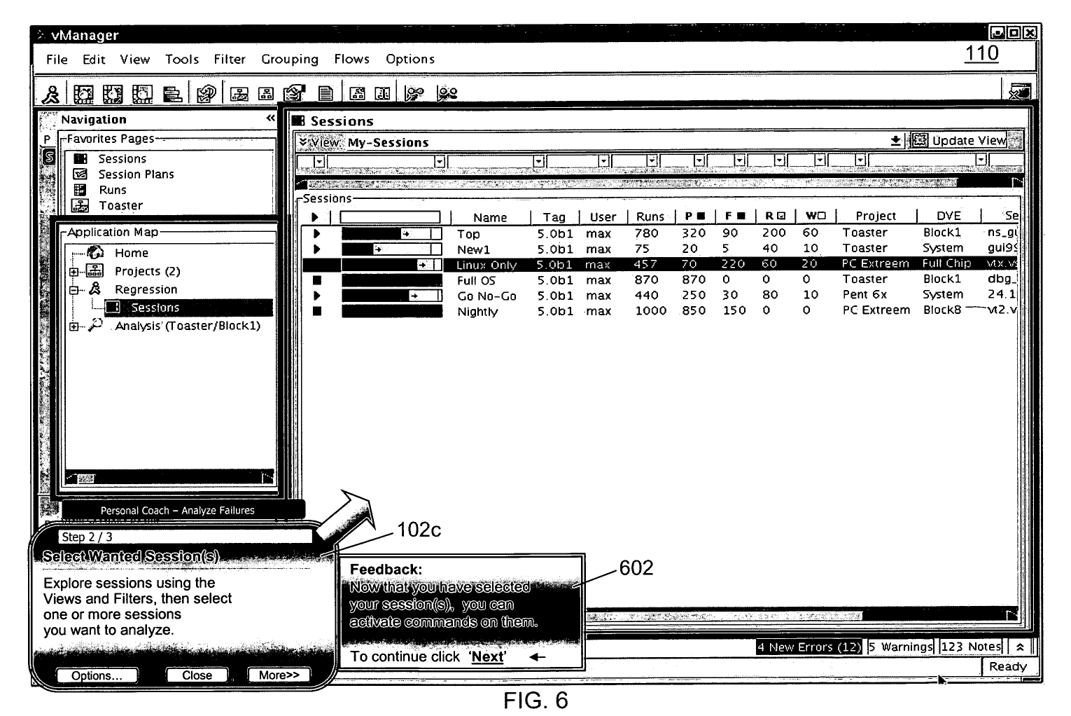

The screenshot of FIG. 6 depicts the floating frame 102c associated the coach, according to an embodiment of the invention. In FIG. 5, the instructions displayed in floating frame 102c instruct the user to select sessions for analyzing and the “Sessions” pane is pointed at by arrow 506. In response to interacting with the “Sessions” pane of user interface 110 by selecting a session file, the software application responsively performs an action. According to an embodiment, the coach is configured to provide feedback regarding what the software application did in response to enacting a step and/or task. As depicted in FIG. 6, floating frame 102c provides such feedback to the user via a feedback frame 602. In the example of FIG. 6, the feedback frame 602 informs that upon the user selecting a session, the user can activate commands thereon. According to an embodiment, feedback frame 602 comprises a “Next” link that the user can use to instruct the coach to continue with the task at hand.

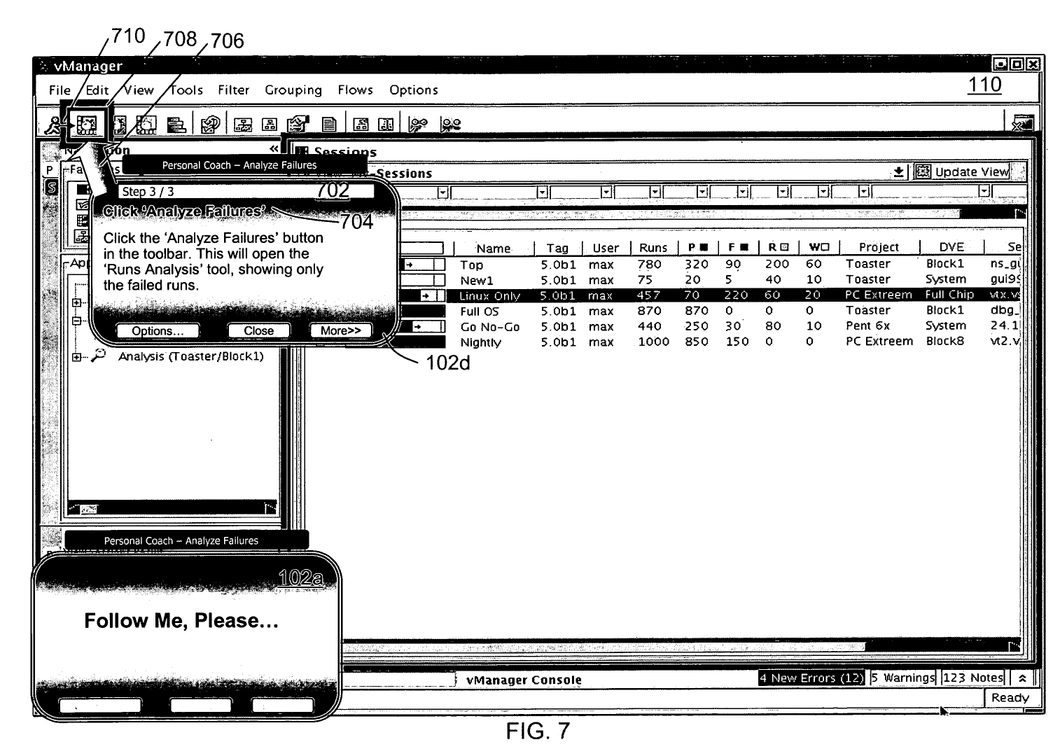

The screenshot of FIG. 7 depicts, generally, the floating frame 102 associated with the coach, in two different locations, according to an embodiment of the invention. Floating frames 102a and 102d may be implemented as the same frame, with its content and location changing. Alternatively, floating frames 102a and 102d may be implemented as separate instances or objects of a floating frame mechanism, generally.

In response to the previous step of selecting a session from the “Sessions” pane (see, e.g., FIG. 6), the floating frame 102a leads the user to another location within user interface 110 by momentarily displaying some dialogue, such as “Follow Me, Please . . . ”. The floating frame 102a then moves to a new location over user interface 110, depicted as floating frame 102d of FIG. 7. Floating frame 102d displays the step tracker 702 corresponding to the “Analyze Failures” task, where the step tracker 702 describes with which step of the “Analyze Failures” task the floating frame 102d is associated (e.g., “Step 3/3”). Floating frame 102d also displays the title 704 of the particular step of the particular task which, in this part of the example, is the “Click ‘Analyze Failures'” step of the “Analyze Failures” task. As with floating frame 102 of FIG. 1, floating frame 102d may display the Options and More buttons.

As with other steps of the task, the manner in which floating frame 102a transitions into and moves to the location of floating frame 102d is such that the floating frame appears to graphically “slide” from location to location so that the user can visually follow the movement of the floating frame to the new location, according to an embodiment. According to an embodiment, the content of floating frame 102a changes to the content of floating frame 102d upon reaching the location associated with floating frame 102d. As with other steps, the exact timing of when the content of floating frame changes may vary from implementation to implementation.

Floating frame 102d provides instructions to the user by displaying instructions about how the user should interact with user interface 110, in order to cause actual performance, by the software application, of one or more operations associated with the third step of the “Analyze Failures” task. Furthermore, floating frame 102d graphically points to a portion of the user interface 110 with which the user is supposed to interact, which in this step is a toolbar icon. For example, arrow 706 points to the “Analyze Failures” icon of the toolbar of user interface 110.

As with the other steps, the portion of user interface 110 with which the user should interact in order to perform the third step may be emphasized within user interface 110. The portion of the user interface in which the component is contained may be a window, a frame, a pane, an icon, etc., depending on the design and configuration of the user interface 110. For example, FIG. 7 shows the “Analyze Failures” toolbar icon as having a bold border 708, and somewhat exploded, compared to the other sections of the user interface 110. Similarly, if a given step may be performed in the software application in multiple ways, then portions of the user interface associated with each respective way to perform the step is highlighted or otherwise emphasized. As with other steps, the user interface component associated with the step may be graphically emphasized by pointing directly to the component, such as with arrow 710 depicted in FIG. 7.

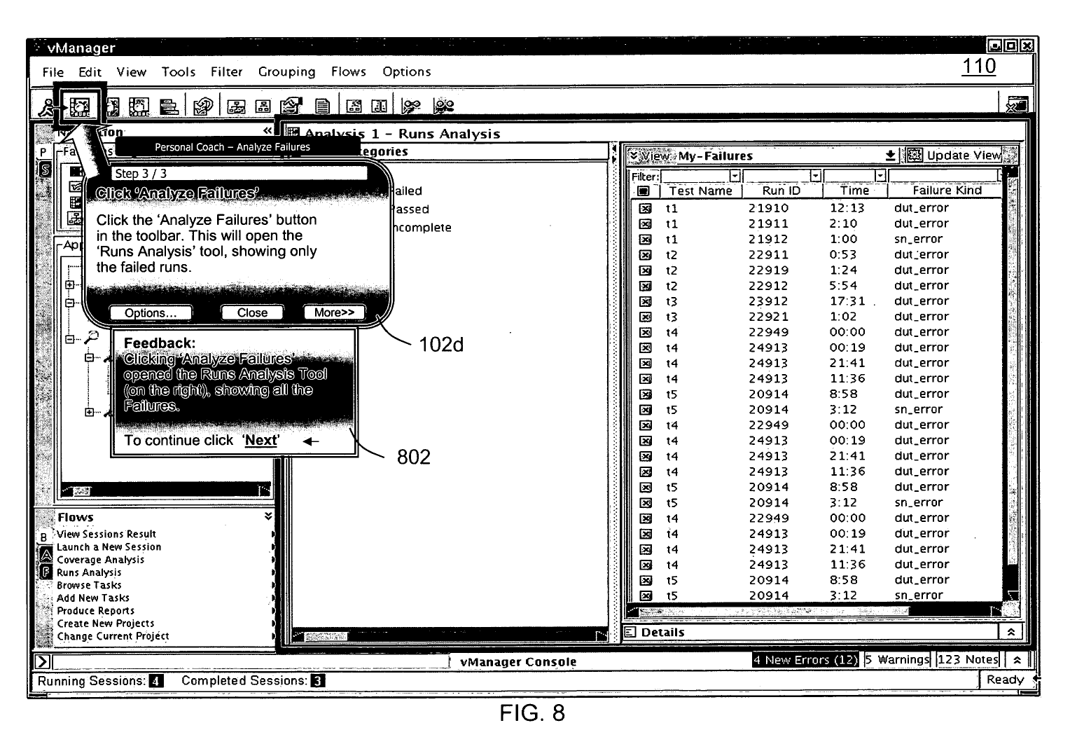

The screenshot of FIG. 8 depicts the floating frame 102d associated with the coach, according to an embodiment of the invention. In FIG. 7, the instructions displayed in floating frame 102d instruct the user to click the “Analyze Failures” icon and that icon is pointed at by arrow 706. In response to interacting with the “Analyze Failures” icon of user interface 110, the software application responsively performs an action. According to an embodiment, the coach is configured to provide feedback regarding what the software application did in response to enacting a step and/or task. As depicted in FIG. 8, floating frame 102d provides such feedback to the user via a feedback frame 802. In the example of FIG. 8, the feedback frame 802 informs that clicking the “Analyze Failures” icon opened the “Runs Analysis Tool”, showing all the failures. According to an embodiment, feedback frame 802 comprises a “Next” link that the user can use to instruct the coach to continue with the task at hand.

### Providing a Summary and Related Task Flows

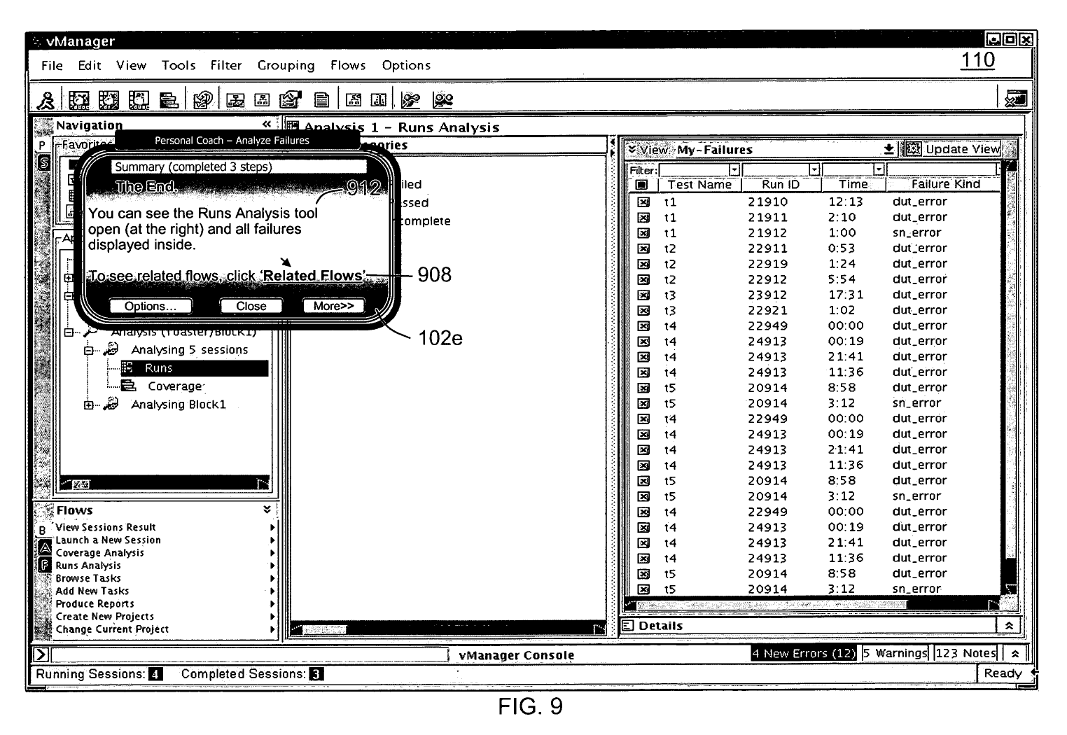

The screenshot of FIG. 9 depicts the floating frame 102e associated with the coach, according to an embodiment of the invention. According to an embodiment, in response to completing a task, the floating frame 102e displays a “Summary” corresponding to completion of the “Analyze Failures” task, where the summary 912 generally describes or explains the result of the “Analyze Failures” task. As with floating frame 102 of FIG. 1, floating frame 102b may display the Options and More buttons.

According to an embodiment, a summary-based floating frame (e.g., floating frame 102e of FIG. 9) comprises a “Related Flows” link 908 which the user can exercise to request the coach to display one or more options for how to perform tasks associated with the software application which are, or may be, related to the task just finished.

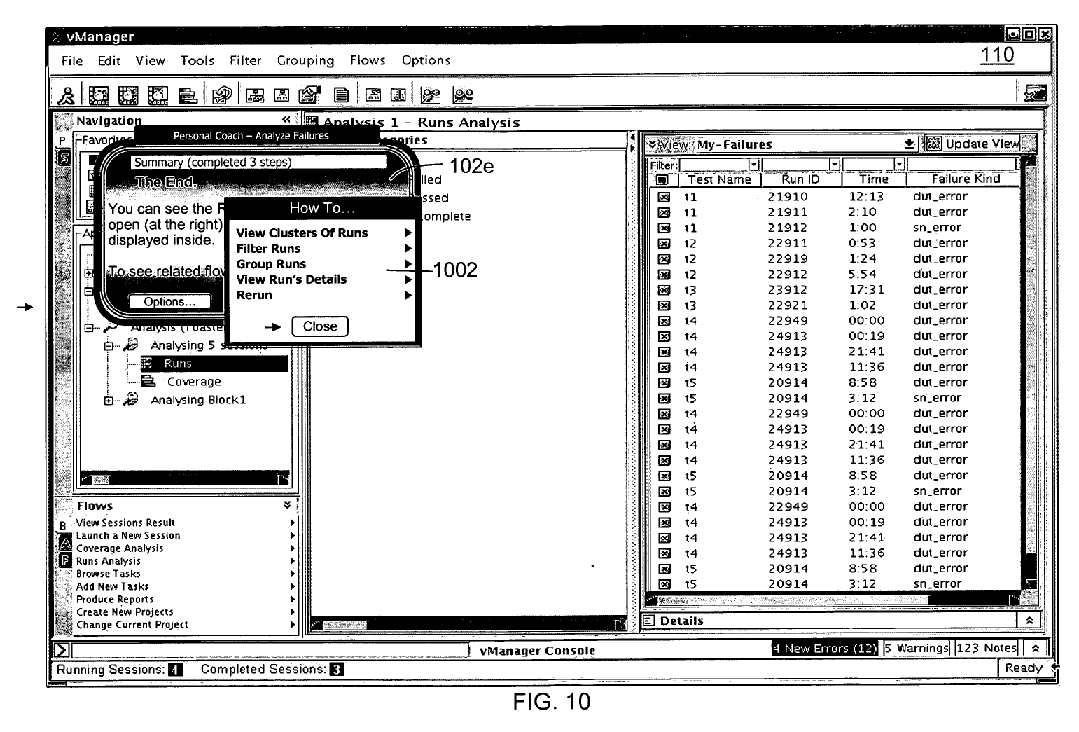

The screenshot of FIG. 10 depicts the floating frame 102e associated with the coach, according to an embodiment of the invention. In response to exercising the “Related Flows” link 908 of floating frame 102e (FIG. 9), the coach displays the names of one or more tasks, or flows, that are considered to be related to the task just finished. As depicted in FIG. 10, floating frame 102e provides such related flows options to the user via a related flows frame 1002. For non-limiting examples, clicking on the “Related Flows” link may cause display of a dialogue box in conjunction with the floating frame 102e, or expand the size of the floating frame 102e, where the related flows frame 1002 identifies one or more related tasks. In the example of FIG. 10, the related flows frame 1002 provides links to descriptions and/or instructions about how to perform various related tasks, such as “View Clusters of Runs”, “Filter Runs”, “Group Runs”, “View Run's Details”, and “Rerun”.

### A Method for Leading a User in Performing a Task

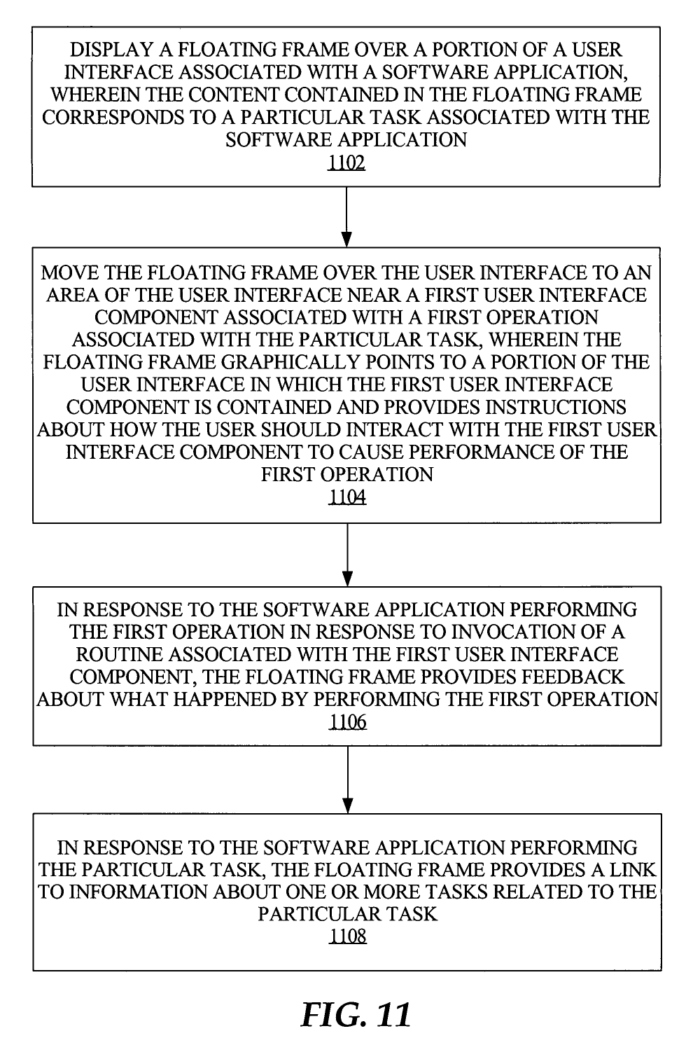

FIG. 11 is a flow diagram illustrating a method for leading a user in performing a task using at least one software application, according to an embodiment of the invention. The method depicted in FIG. 11 is a computer and/or machine-implemented method in which a computer or machine performs the method, such as by one or more processors executing instructions. For example, the method may be performed on or by a computer system such as computer system 1200 of FIG. 12.

1 At block 1102, a floating frame is displayed over a portion of a user interface associated with a software application, where the content contained in the floating frame corresponds to a particular task associated with the software application. For example, floating frame 102 (FIG. 1) is displayed over user interface 110 (FIG. 1) for the vManager application, in response to invocation of the personal coach described herein. As mentioned, the manner in which the coach is invoked may vary from implementation to implementation, and the floating frame may comprise, for example, a window, frame, pane, or other type of dialogue box that is displayed over or on top of the user interface 110 corresponding to the software application, such that the floating frame is displayed in a manner that covers a portion of the underlying user interface 110.

At block 1104, the floating frame is moved over the user interface to an area of the user interface near a first user interface component associated with a first operation associated with the particular task. At this stage, the floating frame graphically points to a portion or area of the user interface in which the first user interface component is contained. Further, the floating frame displays or otherwise provides (e.g., using audio) instructions about how the user should interact with the first user interface component to cause performance of the first operation, which corresponds to at least part of the first step of the particular task. For example, the floating frame 102 transitions into floating frame 102b (FIGS. 2 and 3), possibly via intermediate floating frame 102a (FIG. 2), and slides to a location near the “Application Map” of user interface 110 (FIGS. 2 and 3). Moving “near” the user interface component comprises moving to a location relatively and substantially close to the portion of the user interface in which the user interface component is contained (e.g., the “Application Map” pane of FIGS. 2 and 3) and/or to the user interface component itself (e.g., the “Regression” and “Sessions” links within the “Application Map” pane of FIGS. 2 and 3, and the toolbar icon of FIG. 7). Further with the example, floating frame 102b points to the “Application Map” pane using arrow 206 (FIG. 2), and instructs the user to select the “Sessions” page in the application map inside the “Regression” node.

At block 1106, in response to the software application performing the first operation in response to invocation of a routine associated with the first user interface component, the floating frame provides feedback about what happened by performing the first operation. As mentioned, the feedback mechanism is optional and may be implemented as user-configurable; therefore, block 1106 is an optional step. For example, a routine associated with the first operation and the first user interface component may be invoked (a) by the user clicking on the first user interface component, or (b) by the coach itself if the coach is functioning in semi-automatic mode as described in greater detail herein, e.g., by commanding the application to perform the operation as if the interface component was actually exercised even when the interface component was not actually exercised. Continuing with the example, once the first operation is completed, the floating frame 102b provides feedback via feedback frame 402 (FIG. 4).

At block 1108, in response to the software application performing the particular task (e.g., or an operation if the particular task is a single-step task), the floating frame provides a link to information about one or more tasks related to the particular task. For example, floating frame 102e (FIG. 9) displays a “Related Flows” link 908 (FIG. 9) along with a summary 912 (FIG. 9). When the link 908 is clicked or otherwise exercised, the related flows frame 1002 (FIG. 10) is displayed or otherwise provided in conjunction with the floating frame 102e, showing “How To . . . ” links to further information about various tasks related to the particular task just completed.

Hence, the coach provides a mechanism for leading a computer application user in performing tasks using the application, by coaching the user while the user is executing real tasks. The coach teaches the user how to use the application to perform certain tasks, and provides the user means for obtaining information regarding specific tasks. The coach exists “inside” the application and provides the user instructions in real time while the user is executing a real task, e.g., through the floating frame “floating” above a portion of the user interface in a manner that does not completely cover the interface so that the user can still view a large portion of the interface. Moreover, those instructions are provided in a manner that requires only a low workload focus from the user, by using visual means or any other media such as audio.

The personal coach may be implemented to handle tasks that require multiple application windows, whereby the floating frame is made to travel between the multiple windows while operating as described herein. Furthermore, the personal coach may be implemented to handle tasks that require multiple applications, whereby the floating frame is made to travel between the multiple applications' interfaces while operating as described herein.

Another extension of the personal coach involves steps that can be invoked in more than one way. As mentioned as examples, if a certain task may be performed via a menu selection, a toolbar icon, a link, and a button, then each of the menu selection, icon, link, and button are concurrently emphasized. Furthermore, according to an embodiment, each alternative way in which the step may be performed is described. For example, the floating frame may display a bullet list of the options, with short explanations of the process involved with each respective option. For another example, the floating frame may display a bullet list of the options, with a “Show Me” or similar link or button which, when exercised, provides additional information about a selected option. In either example case, when an option is selected from the list, according to an embodiment the floating frame points to the portion(s) of the user interface associated with the selected option.

### Semi-Automatic Mode

According to an embodiment, the coach is configurable to operate in a semi-automatic mode, in which the coach causes performance of one or more of the deterministic steps involved in the task, which do not require a user selection. In the context of the example illustrated with FIGS. 1-10, the coach could perform Step 1/3 by effectively clicking (or commanding the application directly, external to the user interface) on the “Regression” node within the “Application Map” pane of user interface 110 and click on the “Sessions” page link under the “Regression” node, while skipping display of the feedback if so configured.

The coach may also move the floating frame around different areas of the user interface, based on the step that the coach is performing at any given time in the execution process, to provide some visual feedback to the user as to what the coach is doing. According to an embodiment, the coach commands the software application's user interface program to simulate an interaction with the pertinent user interface component in conjunction with the software application performing the corresponding operation in semi-automatic mode, thereby providing the user additional visualization of what the coach is doing in relation to the task.

Once a user selection is required, such as with Step 2/3 of the example, the coach may display a prompt to the user by displaying an emphasized instruction within the floating frame, such as highlighted text prompting “Your Move”, or similar, in conjunction with a floating frame such as floating frame 102c of FIG. 5. The feedback frame 602 of FIG. 6 may be displayed in response to the user performing the prompted action, e.g., selecting a session from the “Sessions” pane, even though the coach may be configured to not display feedback for the steps whose performance is automatically caused by the coach. In semi-automatic mode, the coach may be configured to execute other features described herein, such as the summary feature and the related flows feature.

### Task and Step Data Structures

In leading a user through performance of a task, the coach needs information about the task and steps that the user wants to perform, e.g., a knowledge base of task flow and step information. As mentioned, in the case of an external coach application communicating with the software application via an API, the application may pass task and step definitions to the coach. Alternatively, the task and step definition information may be stored in a repository accessible to the coach. In the case of a coach application integrated into a software application, the task and step definition information may be stored in a repository accessible to the coach.

According to an embodiment, in the context of the personal coach a task is defined as having certain attributes, as follows.
(a) task identifier (i.e., an ID);
(b) Title;
(c) Initial Location on screen, i.e., where to initially place the floating frame with the Introduction text;
(d) Introduction text;
(e) Summary text;
(f) optionally, a link into a more elaborate explanation of the task, for example, using some HTML pages or a link to the Online-Help;
(g) List of the steps that comprise the Task; and
(h) List of related Tasks, i.e., for the “Related Flows” feature. Some of the above attributes are optional, such as the initial location on screen, the link to more elaborate explanation, and the list of related tasks.

According to an embodiment, in the context of the personal coach a step constituent to a task (e.g., a task-step) is defined as having certain attributes, as follows.
(a) Title;
(b) Serial Number (e.g., step 3/3);
(c) Description;
(d) Relevant area of the user interface, e.g., for emphasizing and/or pointing to, which can be represented by one of the following:
   (d1) fixed X1,Y1, X2, Y2 coordinates, and
   (d2) a specific named component in the software application user interface;
(e) Instruction text;
(f) Expected Component Event(s), which are used to provide the user with feedback in response to notification of an occurrence of the event, depending on the specific event and state;
(g) Successful Feedback text; and
(h) Failure Feedback text.
   Optionally, a link into a more elaborated explanation or to the Online-Help regarding this specific step may be included in a step definition. Whether the Successful Feedback text or the Failure Feedback text is displayed depends on whether the corresponding step was completed correctly, which is based on whether the real event matches the expected component event.

### Implementation Mechanisms

Some possible approaches to implementing the personal coach functionality described herein are described generally as follows. For example, the coach can be implemented as a built-in mechanism integrated within a particular software application, or as a separate mechanism that interacts with various software applications (e.g., a plug-in application). In the case in which the coach is implemented as an external application, the coach should have the capability to connect to other software applications using an external communication method, for example, via sockets. Because in this case the coach can serve various types of applications, the coach will not define a predefined set of available tasks. Rather, every time a software application invokes the coach, the software application will pass the details of the specific requested task, including the data that was specified in the above task definition.

After the coach starts to handle a specific task, the coach communicates with the related software application using APIs (application programming interfaces), such as the following.

Get Task Data: At first, the coach receives the details of the Task definition.

Pop Personal Coach GUI: Using the Task details, upon invocation of the coach, the coach application pops up the coach GUI, in the specified location, displaying the specified details (introduction, etc.) and including a Start button or link.

1 After User Hits ‘Start’, Move to Location of Step #1: Once the user hits Start, the coach will start step #1, which moves the coach GUI to a different location, next to the area which was defined in Task-Step #1. Note that the new location is calculated such that the coach GUI will be next to the defined area, but will not hide any of it, if possible. If the relevant area was defined using fixed coordinates, then the coach will immediately relocate according to those coordinates. If the relevant area was defined using a specific GUI component name, then the coach will communicate with the software application to request the coordinates of the relevant component, and will then relocate next to that location.

Highlight and Point to Relevant Area: After the coach GUI relocates, the coach will highlight the relevant area with visual emphasis, such as by surrounding it with a thick colored border. After the area is highlighted, the coach will draw a visual pointer, such as by using a thick colored arrow, which will point from the coach GUI to the relevant highlighted area.

Register for Receiving Expected User Events: Once the coach is located, it communicates with the software application and registers for events according to the Expected Component Event data of the corresponding task-step. After registering for certain events, the coach will wait for user interaction with the user interface.

After User Operation, Show Feedback: Once the user performs an operation that triggers the expected event, the coach will receive this event and analyze the event properties and the application state. This analysis will lead to displaying the appropriate feedback to the user, e.g., either successful feedback or failure feedback explaining how to correct the user mistake. If the user performed an incorrect step and received a failure feedback, then the user will be instructed again to fix the same step and new feedback will be displayed after the user acts accordingly.

After User Hits ‘Continue, Move to Location of Step #2: Eventually, when user hits Continue, the coach will follow the next step, and go over the above cycle again.

After Last Step Executed, Show Task Summary: When user completes all task-steps for a given task, the coach will display task Summary, including what was performed and any other relevant information.

The coach can be implemented to provide help for a fixed set of tasks, or can be designed to support extensions, thereby allowing users to define more tasks. For example, users may define tasks that are specific to their profession, area or site, and easily extend the repository of tasks to contain those user-defined tasks. Such an extension can be implemented using an open architecture, allowing end users to use a specific API through which users add tasks, where each task is defined with attributes as described herein. Such an API also allows plug-in coach developers to add more Help information regarding their plug-in coach for use by the coach upon a user request.

For example, the foregoing extension can be implemented via a record-replay mechanism, by which a user can simply execute some moves in the application, which will be automatically turned into a task. Later, this task can be configured generally by setting the task's degrees of freedom so that the task can relate to any user real data and not only to the recorded data. Generalizing the task definition can be performed by eliminating the actual data in the record-replay session, and leaving only the definition of areas and components in the application's user interface that should be used by the end user in performing the corresponding task.

### Hardware Overview

FIG. 12 is a block diagram that illustrates a computer system 1200 upon which an embodiment of the invention may be implemented. Computer system 1200 includes a bus 1202 or other communication mechanism for communicating information, and a processor 1204 coupled with bus 1202 for processing information. Computer system 1200 also includes a main memory 1206, such as a random access memory (RAM) or other dynamic storage device, coupled to bus 1202 for storing information and instructions to be executed by processor 1204. Main memory 1206 also may be used for storing temporary variables or other intermediate information during execution of instructions to be executed by processor 1204. Computer system 1200 further includes a read only memory (ROM) 1208 or other static storage device coupled to bus 1202 for storing static information and instructions for processor 1204. A storage device 1210, such as a magnetic disk or optical disk, is provided and coupled to bus 1202 for storing information and instructions.

Computer system 1200 may be coupled via bus 1202 to a display 1212, such as a cathode ray tube (CRT) or liquid crystal display (LCD), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

The invention is related to the use of computer system 1200 for implementing the techniques described herein. According to an embodiment of the invention, those techniques are performed by computer system 1200 in response to processor 1204 executing one or more sequences of one or more instructions contained in main memory 1206. Such instructions may be read into main memory 1206 from another machine-readable medium, such as storage device 1210. Execution of the sequences of instructions contained in main memory 1206 causes processor 1204 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 1200, various machine-readable media are involved, for example, in providing instructions to processor 1204 for execution. Such a medium may take many forms, including but not limited to, non-volatile media, volatile media, and transmission media. Non-volatile media includes, for example, optical or magnetic or magneto-optical disks, such as storage device 1210. Volatile media includes dynamic memory, such as main memory 1206. Transmission media includes coaxial cables, copper wire and fiber optics, including the wires that comprise bus 1202. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 1204 for execution. For example, the instructions may initially be carried on a magnetic disk of a remote computer. The remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on bus 1202. Bus 1202 carries the data to main memory 1206, from which processor 1204 retrieves and executes the instructions. The instructions received by main memory 1206 may optionally be stored on storage device 1210 either before or after execution by processor 1204.

Computer system 1200 also includes a communication interface 1218 coupled to bus 1202. Communication interface 1218 provides a two-way data communication coupling to a network link 1220 that is connected to a local network 1222. For example, communication interface 1218 may be a digital subscriber line (DSL), cable, or integrated services digital network (ISDN) card or a modem to provide a data communication connection to a corresponding type of telephone line. As another example, communication interface 1218 may be a local area network (LAN) card to provide a data communication connection to a compatible LAN. Wireless links may also be implemented. In any such implementation, communication interface 1218 sends and receives electrical, electromagnetic or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the world wide packet data communication network now commonly referred to as the “Internet” 1228. Local network 1222 and Internet 1228 both use electrical, electromagnetic or optical signals that carry digital data streams. The signals through the various networks and the signals on network link 1220 and through communication interface 1218, which carry the digital data to and from computer system 1200, are exemplary forms of carrier waves transporting the information.

Computer system 1200 can send messages and receive data, including program code, through the network(s), network link 1220 and communication interface 1218. In the Internet example, a server 1230 might transmit a requested code for an application program through Internet 1228, ISP 1226, local network 1222 and communication interface 1218.

The received code may be executed by processor 1204 as it is received, and/or stored in storage device 1210, or other non-volatile storage for later execution. In this manner, computer system 1200 may obtain application code in the form of a carrier wave.

### Extensions and Alternatives

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

Alternative embodiments of the invention are described throughout the foregoing specification, and in locations that best facilitate understanding the context of the embodiments. Furthermore, the invention has been described with reference to specific embodiments thereof. It will, however, be evident that various modifications and changes may be made thereto without departing from the broader spirit and scope of the invention.

In addition, in this description certain process steps are set forth in a particular order, and alphabetic and alphanumeric labels may be used to identify certain steps. Unless specifically stated in the description, embodiments of the invention are not necessarily limited to any particular order of carrying out such steps. In particular, the labels are used merely for convenient identification of steps, and are not intended to specify or require a particular order of carrying out such steps.

What is claimed is:

1. A computer-implemented method for leading a user in performing a task using at least one software application, the method comprising:
displaying a floating frame over a portion of a user interface associated with said software application, wherein content contained in said floating frame corresponds to a particular task associated with said software application; and
moving said floating frame over said user interface to an area of said user interface near a first user interface component associated with a first operation associated with said particular task, wherein said floating frame graphically points to a portion of said user interface in which said first user interface component is contained and provides instructions about how said user should interact with said first user interface component to cause performance of said first operation;
wherein said software application performs said first operation in response to invocation of a routine associated with said first user interface component.

2. The method of claim 1, wherein moving said floating frame over said user interface includes displaying said moving of said floating frame.

3. The method of claim 1, further comprising:
graphically emphasizing said portion of said user interface in which said first user interface component is contained.

4. The method of claim 1, further comprising:
graphically emphasizing said first user interface component.

5. The method of claim 1, further comprising:
graphically pointing to said first user interface component.

6. The method of claim 1, wherein performance of said first operation can be caused using said first user interface component and can be caused using a second user interface component associated with said first operation, the method further comprising:
concurrently graphically emphasizing said portion of said user interface in which said first user interface component is contained and a portion of said user interface in which said second user interface component is contained.

7. The method of claim 6, further comprising:
said floating frame providing instructions to select one of said first user interface component and said second user interface component.

8. The method of claim 1, further comprising:
in response to said software application performing said first operation, said floating frame providing feedback about what happened by performing said first operation.

9. The method of claim 8, wherein providing feedback about what happened by performing said first operation includes providing said feedback in response to receiving an event notification generated by said software application, wherein said event notification indicates that an interaction with said first user interface component was performed.

10. The method of claim 1, further comprising:
in response to said software application performing said first operation, said floating frame providing a link to information about one or more tasks related to said particular task.

11. The method of claim 1, wherein said software application performs said first operation in response to invocation of said routine in response to an interaction by said user, with said first user interface component, complying with said instructions.

12. The method of claim 1, wherein said software application performs said first operation in response to invocation of said routine in response to an automated interaction, with said first user interface component, complying with said instructions.

13. The method of claim 1, further comprising:
invoking said routine; and
instructing said software application to graphically simulate an interaction with said first user interface component.

14. The method of claim 1, further comprising:
moving said floating frame over said user interface to an area of said user interface near a second user interface component associated with a second operation associated with said particular task, wherein said floating frame graphically points to a portion of said user interface in which said second user interface component is contained and provides instructions about how said user should interact with said second user interface component to cause performance of said second operation;
wherein said software application performs said second operation in response to invocation of a routine associated with said second user interface component.

15. The method of claim 1, wherein said software application is a first software application and said user interface is a first user interface, and wherein said particular task includes said first operation associated with said first software application and a second operation associated with a second software application that is a different application from said first software application, the method further comprising:
moving said floating frame over a second user interface associated with said second software application to an area of said second user interface near a second user interface component associated with said second operation, wherein said floating frame graphically points to a portion of said second user interface in which said second user interface component is contained and provides instructions about how said user should interact with said second user interface component to cause performance of said second operation;
wherein said second software application performs said second operation in response to invocation of a routine associated with said second user interface component.

16. A machine-readable storage medium carrying one or more sequences of instructions which, when executed by one or more processors, causes performance of the method recited in claim 1.

17. A machine-readable storage medium carrying one or more sequences of instructions which, when executed by one or more processors, causes performance of the method recited in claim 2.

18. A machine-readable storage medium carrying one or more sequences of instructions which, when executed by one or more processors, causes performance of the method recited in claim 8.

19. A machine-readable storage medium carrying one or more sequences of instructions which, when executed by one or more processors, causes performance of the method recited in claim 15.

20. A system comprising:
a memory;
a processor;
a display;
one or more sequences of instructions stored in said memory, said instructions which, when executed by the processor, cause performance of:
in response to said user identifying a particular task associated with said software application, displaying on said display a floating frame over a portion of a user interface associated with said software application, wherein content contained in said floating frame corresponds to said particular task; and
moving said floating frame over said user interface to an area of said user interface near a first user interface component associated with a first operation associated with said particular task, wherein said floating frame graphically points to a portion of said user interface in which said first user interface component is contained and provides instructions about how said user should interact with said first user interface component to cause performance of said first operation;
wherein said software application performs said first operation in response to invocation of a routine associated with said first user interface component.
